(19) United States
(12) Patent Application Publication
(10) Pub. No.: US 2006/0253800 A1
(43) Pub. Date: Nov. 9, 2006

(54) Soliciting and reporting feedback

(76) Inventors: Thomas O. Jones, Andover, MA (US); John F. Cardinal, North Andover, MA (US); Paul E. Wentzell, Sandown, NH (US); Edward W. Parker, Andover, MA (US); Edward J. Boudrot, Lexington, MA (US)

Correspondence Address: FISH & RICHARDSON PC, P.O. BOX 1022, MINNEAPOLIS, MN, 55440-1022, US

(21) Appl. No.: 11/125,617

(22) Filed: May 9, 2005

(51) Int. Cl. G06F 9/00

(52) U.S. Cl. 715/810

(57) ABSTRACT

A method includes (a) electronically presenting to a user, graphical or audible representations of two or more possible reactions in a range of a reactions to an occurrence or a proposition, the two or more different graphical or audible representations sharing a common representational concept, (b) enabling the user to indicate a selected reaction to the occurrence or proposition that is within the range, and (c) associating the user's indication with one of the graphical or audible representations.

### BACKGROUND

This description relates to soliciting and reporting feedback.

Feedback on a person's reaction to an occurrence or a proposition typically is solicited by interview or questionnaire, and the results are reported numerically, statistically, in text, or in graphs or charts. For example, a user could be asked whether he is satisfied or not with his use of a computer program or whether he agrees or not with the proposition that Jimmie Carter was the nation's best president.

### SUMMARY

In general, in one aspect, a method includes (a) electronically presenting to a user, graphical or audible representations of two or more possible reactions in a range of a reactions to an occurrence or a proposition, the two or more different graphical or audible representations sharing a common representational concept, (b) enabling the user to indicate a selected reaction to the occurrence or proposition that is within the range, and (c) associating the user's indication with one of the graphical or audible representations.

Implementations of the invention may include one or more of the following features. The user is enabled to indicate the selected reaction from among a greater number of possible reactions within the range than there are graphical or audible representations. The user is enabled to indicate the selected reaction along a continuous scale corresponding to the range. There is a continuous range of the reaction and the graphical or audible representations are continuously variable. The selection is indicated by a position of a slider control of a user interface. The presentation of the graphical or audible representations is determined at least in part by the selection by the user. The graphical or audible representations comprise images or sounds that are expressive of different states of human reaction. The representations are of at least three different degrees of reaction. The user is enabled to provide audible or written prose comments associated with the selection. The user is enabled to make the selection tentatively and to confirm the tentative selection to have it registered. The confirmed selection is stored. The graphical and audible representations are presented to other users, and the other users are enabled to make the selections. The selections of the users are analyzed and the results of the analysis are reported. The selections may be grouped by category of user or entity. Information about the selection is reported to another user by presenting at least one of the graphical or audible representations. The occurrence or proposition comprises the user's satisfaction with a service or product used by the user. The graphical or audible representations are presented in a window of a graphical user interface. The reaction comprises a single overall reaction to the occurrence or proposition.

In general, in another aspect, a method includes electronically presenting to a user at least one graphical or audible representation of an aggregate degree of reaction of other users to an occurrence or a proposition, the representation being drawn from a set of images or sounds that are expressive of different human reactions.

Implementations may include one or more of the following features.

The representation is presented to the user in a window of a graphical user interface. The user is enabled to select characteristics of the other users whose degree of reaction is represented. Additional graphical or audible representations of historical aggregate degrees of reaction of the other users electronically are presented electronically to the user.

Other advantages and features will become apparent from the following description and from the claims.

### DESCRIPTION

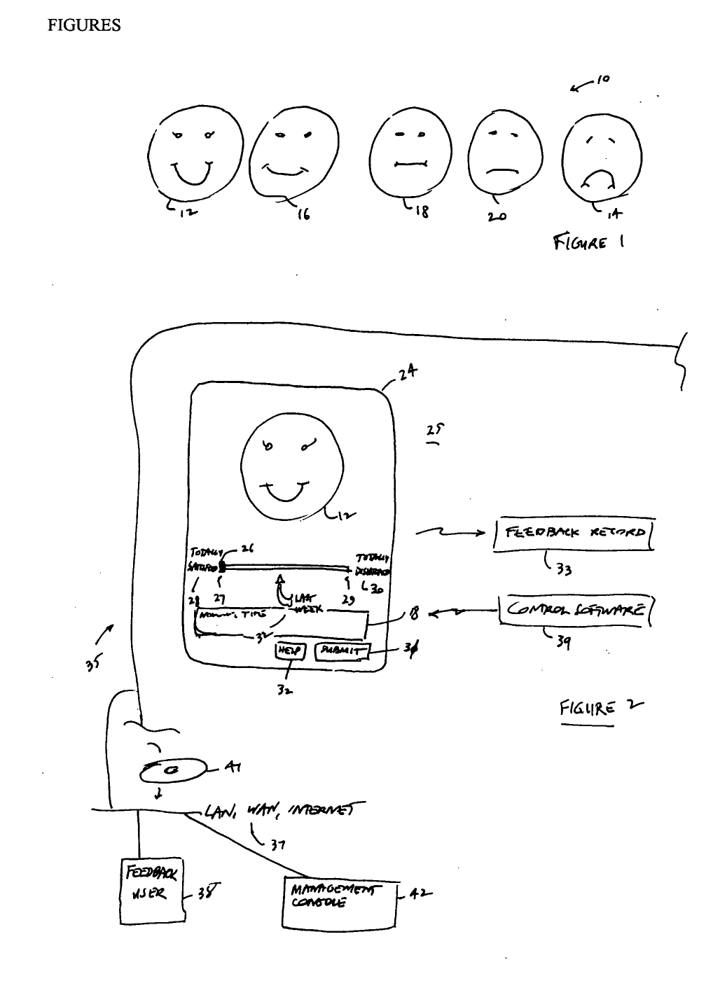

FIG. 1 shows a set of images.

FIG. 2 is a schematic view of a feedback system.

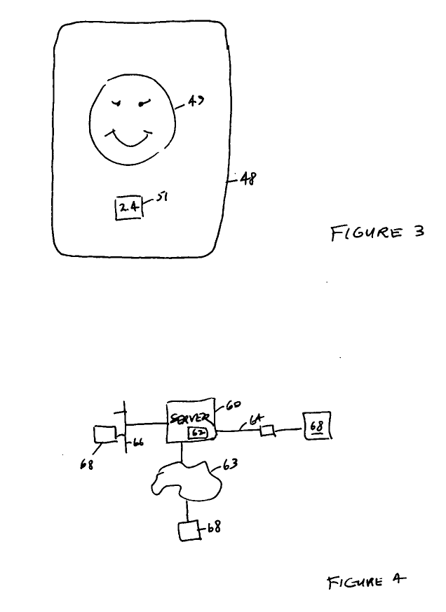

FIG. 3 shows a window of a user interface.

FIG. 4 is a block diagram.

By appropriately arranging the ways that feedback is solicited and reported, the feedback can be solicited more effectively, quickly, simply, and with more accurate and complete results, and the reports of the feedback can be provided in a manner that is more effective and more easily understood.

As shown in FIG. 1, in some implementations of a feedback system, a set 10 of images including a smiley face 12, a frowny face 14, and faces 16, 18, 20 displaying expressions between smiley and frowny are used to represent different degrees in a range of human reaction or emotion, while all sharing a common representational concept (in this case a face with different expressions). The images are used to solicit and report feedback of users with respect to propositions or occurrences. In some implementations, other kinds of representations, not related to human reaction or emotion, could be used.

As shown in FIG. 2, in some examples of soliciting feedback, a window 24 is presented on a computer screen 25. The window includes a slider 26 that can be dragged across a range from a left extreme 27 to a right extreme 29 to indicate a user's reaction to an occurrence or proposition. Labels 28, 30 are provided at each end of the range to indicate the extremes of the possible degrees of reaction within a range that can be expressed using the slider. In the middle of the slider range is a label 32 that alludes to the proposition or occurrence for which the user's feedback is solicited. In this case, the label refers to feedback on the user's satisfaction with the software in the prior week.

In the example of FIG. 2, the window 24 is arranged to display only one of the images 16, 18, 20 at a given time. This enables a very small amount of screen space to be used and for the feedback device to be simple. When the slider is at the far left, image 12 is shown, when at the far right, image 20, and when in the middle, image 18.

The slider can be configured so that, if there are only three possible images the slider can only be set at three possible positions in the range, left, middle, and right. Or the slider could be set up so that the slider can be set at any position along its range. In the latter case, the selection of which image is shown depends on where the slider is stopped along its width. In one arrangement, the width of the slider is divided into three equal segments corresponding respectively to the three different images.

The feedback given by the user could be interpreted as having only three numerical values (say, 0, 5, and 10), in this example, corresponding to the three image. In other implementations, the position at which the slider is set is interpreted as any value between 0 and 10, for example. For example, the user could set the slider 40% of the way from left to right to indicate that his reaction is not quite at the middle. The window would display the image 18, but the value of feedback that would be generated would be a 4.

The window 24 also includes a text box 18 in which the user can type free-form comments associated with the position of the slider (or other comments), a submit button 31 with which the user indicates that the slider position and comments should be registered, and a help button 32 to get help.

The window can be presented to the user only once or can be re-presented to the user for additional feedback. The re-presentation can occur, for example, at the request of the user, or at regular intervals (e.g., once a week), or at times determined by another party.

Each time the window is newly presented to the user for further feedback, the slider could be pre-set at the position set by the user in the previous round of feedback, or at a position that is an average of a number of previous rounds. When the submit button is clicked, the system stores a value associated with the position at which the slider is set and stores the text comments, if any. The identity of the user and other information associated with the feedback (for example, the version of the software that the user is running and the day and time of the feedback, to name two) may also be stored with the slider position and the text comments. The resulting feedback record 33 can be stored on the user's computer 35 alone or along with other similar feedback from earlier rounds.

The feedback of the user may be communicated to other parties 38 for whom the feedback may be useful, for example, the developer or marketer of the software, in the examples discussed above. The communication of the feedback can occur by communication through a network 37, such as a local area network or wide area network of an enterprise. Or the feedback may be communicated through a public network such as the internet.

The feedback window and the software 39 that controls it can be stored and run on the user's computer and may or may not be part of or associated with the software for which the feedback is being given. The feedback window can be a client to a central feedback server that serves multiple clients through the network. In other examples, the feedback window could be served through an internet browser running on the user's computer. Or the feedback could be provided on a tangible medium 41.

Feedback on a given occurrence or proposition can be solicited from multiple (including a very large number of users). The users may (but need not) be affiliated, for example, as employees of a single enterprise, or as users of a single software program, or as subscribers to a single service. By making the feedback window available to a number of users and accumulating and analyzing the results of feedback expressed by them, an overview of the satisfaction or agreement level of a body of users can be produced. The groups of users from whom feedback is solicited may be divided for purposes of obtaining the feedback or analyzing it. For example, employees could be divided into subgroups based on the intensity with which they use a software program, or their level within the organization, or their longevity with the enterprise.

A management console 42 can be provided to run on a computer of a party who controls the solicitation, analysis, management, and reporting of the feedback information.

The management console has three primary functions: group and location management, reporting, and management display.

The group and location manager will provide the ability to add, remove, and manage specific groups and locations to receive a survey or feedback inquiry. Groups could be specified based on demographic characteristics of individuals (everyone older than 40, men versus women, engineers versus customer service representatives) or on reporting relationships (all senior managers), or on other bases. Locations could be specified geographically (all sales offices in Germany), hierarchically (all division sales offices), by function (all stores that provide quick serve food versus all stores that provide wait-staff service). Additionally, the management console would enable the manager to associate specific locations with specific groups. The frequency (every day, once a month) and timing (4 PM Eastern time) of each request for feedback or survey would be controlled using this aspect of the management console.

The management console allows the manager to select the propositions or occurrences that are presented for feedback and select the typographic and/or graphical treatment to be used. The choice of typography and graphics can be queued in advance based on the frequency and timing of the feedback solicitations, for example, a snowman representation in December and a flower representation in April. Display attributes can be managed, for example whether or not to permit the user to input text or not, the type of slider bar to be used, the size of the representation, and so on.

The reporting section of the management console will provide statistical detail of the survey results from the locations and/or groups. This will provide tools to compare and contrast the results from different locations and/or different groups and to compare and contrast historical and current surveys. Written feedback from different locations and groups may also be compared.

Statistical results can be generated, such as average, minimum, mean, maximum for particular periods, for particular groups, and for particular locations. The response rate of a survey also can be reported.

The management display section will enable the result of the specific locations and or groups to be delivered in a variety of ways. For example, results can be communicated through a web browser or by email. Each medium can be controlled through the management console in terms of frequency of distribution and updates.

Thus, with respect to solicitation, the management console allows the manager to determine the number, identities, locations, and demographic characteristics of the set of users for whom a given feedback project should apply. The manager can also select the images that will be used to represent the user reactions, the values that will be associated with various slider positions, whether the text box will be displayed or not, and the phrasing of the occurrence or proposition to be presented to the user, among other things. The console also enables the manager to specify and control the number of instances of feedback that are requested from each user and the timing and frequency of the requests.

The management console also enables the manager to accumulate, manage, analyze, and report the instances of feedback provided by the users. The manager can display and review any of the instances individually and groups of the instances that have been accumulated based on characteristics of the users or of the responses, or of other parameters.

The manager can also specify individual or cumulative results to be presented graphically to other parties using, for example, the same images used in soliciting feedback, or other images. The textual comments may also be reported in their original form or in an aggregated form. The manager can control the parties to whom feedback results are provided, the scope of the results provided to them, and the frequency with which they are provided.

As shown in FIG. 3, the overview feedback can be displayed to any party, for example, to a manager who is responsible for the overall satisfaction or agreement of the group of users. The feedback results can be illustrated in a window 48 that contains a single image that represents an averaging or other statistical accumulation of the results of the feedback. In this example, a smiley face 50 could be displayed to indicate that, of three available images, the smiley face was most representative of the feedback of the group that was solicited. For example, the average response may have had a numerical value of 2.4 indicating that the average response is most appropriately represented by the sun image. The feedback reporting window 48 may also include a report 51 of the average numerical score or other statistical metric.

As shown in FIG. 4, the feedback system may be implemented using a central server 60 on which the management console 62 runs. Connections through the internet 62 or dial up lines 64 or a local area network 66 to users' computers 68 permit the solicitations of feedback to be delivered to the user computers, the feedback to be accumulated centrally, and the reports of the feedback to be delivered to the manager or other computers for review.

The feedback system can be implemented on a variety of hardware and communication platforms using a variety of software development platforms.

By making the window that solicits the feedback quite simple (only a single image shown at a time) In addition to the implementations already described, other implementations are within the scope of the claims.

For example, a variety of images, groups of images, and ranges of images can be used to represent user reaction. Examples of representational concepts expressed over a range include prince to frog, crying to giggling, pennies to bags of cash, old jalopy car to fast shiny car, rain to sun, cave to mountain, night to day, ice cubes to hot poker, tack to fur, dead flower to full of life blossom, still fan to spinning fan, coal to gold, dry desert to lush forest, thumbs down to thumbs up, porcupine to silk, cold to hot, devil to angel, jail to open road, angry to excited, shack to mansion, princess to ogre, and famine to feast Although we have used the word feedback to describe what the user is doing, a wide range of responses including others than typical feedback are possible. In general, any reaction to an occurrence or proposition could be the subject of the response by the user. In some specific examples, the could be the user's general state of mind, or his level of affection for another person, or his level of frustration with his supervisor.

The feedback could be sought or reported on a variety of devices other than a computer, including mobile devices like cellular telephones or personal digital assistants, or laptop computers, to name a few.

Other graphical controls could replace the slider for providing feedback.

A range of images could be created in large or infinite numbers by morphing between two images using morphing software. Then any value that could be indicated by the slider could be shown in a unique version of the image.

The images used to illustrate possible user reactions could be short video clips rather than still images, for example, a clip of a rainy day and a clip of a sunny day. The representations of possible reactions need not be visual, but could be audible sounds, for example, laughing and crying or screaming a whispering.

The set of images used for a given feedback project need not have a common conceptual theme. For example, a smiley face could be used for one end of the slider and a rainy day for the other end.

More than one of the images representing possible reactions may be shown at one time in the feedback window.

Comments given by the user can be provided audibly rather than in writing.

1. A method comprising
electronically presenting to a user, graphical or audible representations of two or more possible reactions in a range of a reactions to an occurrence or a proposition, the two or more different graphical or audible representations sharing a common representational concept,
enabling the user to indicate a selected reaction to the occurrence or proposition that is within the range, and
associating the user's indication with one of the graphical or audible representations.

2. The method of claim 1 in which the user is enabled to indicate the selected reaction from among a greater number of possible reactions within the range than there are graphical or audible representations.

3. The method of claim 1 in which the user is enabled to indicate the selected reaction along a continuous scale corresponding to the range.

4. The method of claim 1 in which there is a continuous range of the reaction and the graphical or audible representations are continuously variable.

5. The method of claim 1 in which
the selection is indicated by a position of a slider control of a user interface.

6. The method of claim 1 in which
the presentation of the graphical or audible representations is determined at least in part by the selection by the user.

7. The method of claim 1 in which the graphical or audible representations comprise images or sounds that are expressive of different states of human reaction.

8. The method of claim 1 in which the representations are of at least three different degrees of reaction.

9. The method of claim 1 also including
enabling the user to provide audible or written prose comments associated with the selection.

10. The method of claim 1 also including
enabling the user to make the selection tentatively and to confirm the tentative selection to have it registered.

11. The method of claim 10 also including
storing the confirmed selection.

12. The method of claim 1 also including
electronically presenting the graphical and audible representations to other users, and enabling the other users to make the selections.

13. The method of claim 12 also including
analyzing the selections of the users, and
reporting the results of the analysis.

14. The method of claim 1 also including
reporting information about the selection to another user.

15. The method of claim 14 in which the information about the selection is reported to the other user by presenting at least one of the graphical or audible representations.

16. The method of claim 1 in which the occurrence or proposition comprises the user's satisfaction with a service or product used by the user.

17. The method of claim 1 in which the graphical or audible representations are presented in a window of a graphical user interface.

18. The method of claim 1 in which reaction comprises a single overall reaction to the occurrence or proposition.

19. A method comprising
electronically presenting to a user at least one graphical or audible representation of an aggregate degree of reaction of other users to an occurrence or a proposition, the representation being drawn from a set of images or sounds that are expressive of different human reactions.

20. The method of claim 19 in which
the representation is presented to the user in a window of a graphical user interface.

21. The method of claim 20 also including
enabling the user to select characteristics of the other users whose degree of reaction is represented.

22. The method of claim 21 also including electronically presenting to the user additional graphical or audible representations of historical aggregate degrees of reaction of the other users.
